(19) United States
(12) Patent Application Publication
(10) Pub. No.: US 2007/0011090 A1
(43) Pub. Date: Jan. 11, 2007

(54) Electronic exchange and settlement system for cash letter adjustments for financial institutions

(75) Inventors: Dewayne Baker, Bolingbrook, IL (US); Paul O'Toole, Chicago, IL (US)

Correspondence Address: FITZPATRICK CELLA HARPER & SCINTO, 30 ROCKEFELLER PLAZA, NEW YORK, NY, 10112, US

(73) Assignee: THE CLEARING HOUSE PAYMENTS COMPANY L.L.C., New York, NY (US)

(21) Appl. No.: 11/519,356

(22) Filed: Sep. 11, 2006

Related U.S. Application Data
(63) Continuation of application No. 09/802,066, filed on Mar. 8, 2001.

(51) Int. Cl. G06Q 40/00

(52) U.S. Cl. 705/39

(57) ABSTRACT

An electronic exchange system is provided for input and processing of cash letter adjustments between financial institutions and their customers. The system includes a central processor or centralized exchange mechanism and established rules and procedures for operation of the exchange and centralized hardware and software that is accessible through internet or intranet connections. Data for cash letter adjustments are entered to the system by means of standardized electronic formats which may be created from a desktop application or through an electronic interface to the user's mainframe case management system. At a predetermined time, the processor completes the settlement of each of the adjustment transactions and sends the settlement requirements to each of the participating banks or financial institutions. The system also creates a net settlement file in conformity with the “Enhanced Net Settlement” requirements of the Federal Reserve Bank to provide a net settlement of those adjustments through a participant's reserve account at the host Federal Reserve Bank or through a correspondent settling on the participant's behalf at the Federal Reserve Bank. The system also provides an electronic medium for the exchange of informational requests and responses to those requests. The system provides a database of all participants with detailed contact information for each participating financial institution.

The present invention relates to a fully electronic exchange and settlement system for cash letter adjustments for financial institutions delivery of supporting or substantiating documentation is not required to complete the transaction. The system has application to institutions that belong to a single clearinghouse association or any two institutions that have the need to exchange cash letter adjustments with regard to check clearings. While described in the context of a settlement system for cash letter adjustments, the system has broader applications for various types of exchanges, settlements and reconciliation of amounts owed between financial institutions and their customers.

### BACKGROUND OF THE INVENTION

Financial institutions, such as banks, rely on exchange systems to permit settlement of debits and credits relating to processing of checks and other drafts drawn on each respective institution. For example, customers of Bank A will write checks and drafts to make payments from an account at Bank A to various suppliers of goods and services. Those suppliers will deposit the amounts representative of the values of those checks and drafts in their respective accounts at other financial institutions, such as Bank B. Similarly, customers of Bank B will write checks and drafts that are then deposited in accounts at other banks, such as Bank A. The checks and drafts are commonly referred to as “items.”

Each business day, after individual banks have collected and received deposits based on checks and drafts, the banks typically organize, process and present checks to the drawee bank either directly or through a local or national clearinghouse. Each bundle of checks is accompanied by a letter, commonly referred to as a “cash letter,” which is a demand for payment that requests the transfer of a monetary amount to the representing bank equal to the value of checks drawn on that bank. The entire transaction—the cash letter accompanied by the checks—is commonly known as a “cash letter.” For example, Bank A will send a cash letter to Bank B requesting transfer of a monetary amount equal to the value represented on the checks and drafts deposited in Bank A by customers of Bank A that are drawn on accounts of customers of Bank B. Similarly, Bank B will send a cash letter to Bank A with a similar request relating to the value of checks and drafts drawn on accounts of Bank A that represent deposits by customers of Bank B. Similar cash letters are exchanged between numerous banks and other financial institutions representing the clearing and settlement of financial instruments drawn on accounts at each respective financial institution.

These cash letters often include errors and omissions. Errors may be caused in data entry or in other aspects of the processing of checks and drafts in the collection and presentment process. For example, a draft or check that is listed on the cash letter may not be enclosed in the bundle of checks associated with that cash letter. Similarly, an error could be made in calculation or entry of the data relating to a particular item. Other errors may include erroneously charged items or inclusion of an item that does not meet negotiability requirements.

In each of these cases, the bank that detects the error sends a “cash letter adjustment” to the presenting bank. This transaction adjusts the amount shown on the original cash letter by the amount of the error. While the cash letters are often collected through a local clearinghouse arrangement, cash letter adjustments are more often exchanged directly between the involved banks.

A “cash letter adjustment” is the exchange of information between two financial institutions which provides the receiver of the adjustment with the information necessary to correct certain errors or omissions contained in the subject cash letter. Financial transactions may accompany the adjustment. Each of these cash letter adjustments involves a large amount of manual intervention and paper processing. Costs are incurred in data entry, delivery of adjustment forms with supporting documentation and processing. The present invention is directed to providing an electronic system for presentation all information necessary for the transfer of cash letter adjustments between financial institutions, as well as methods for settlement of adjustments. The system may be used by any two financial institutions that have cash letter adjustment issues with respect to one another. The system may also be used by a participating financial institution's customers under agreements with the participant. It is not limited to members of a local clearinghouse arrangement.

### SUMMARY OF THE INVENTION

In one or more embodiments, the system of the present invention substitutes an electronic exchange for the conventional paper based system of cash letter adjustments. The centralized electronic system yields efficiencies and advantages in data input, delivery and communication costs, time expenditures and generation of summary reports.

The system includes a central processor or centralized exchange mechanism. Each of the participating banks or financial institutions must be authorized. System access is restricted to such authorized users. The system includes established rules and procedures for operation of the exchange and centralized hardware and software that is accessible through internet or intranet connections. Accordingly, the centralized system provides consistent adjustment procedures, insures that applicable business rules are applied and that transactions are kept secure.

Data for cash letter adjustments are entered to the system by means of standardized electronic formats which may be created from a desktop application or through an electronic interface to the user's mainframe case management system. Business rules and required information validations are done on the desktop or on a batch transfer client when an electronic interface is used. Database integrity is maintained in the centralized processor or server. At a predetermined time, such as 3 p.m. (Central Time), of each business day, the processor completes the settlement of all of the adjustments letters and sends the settlement requirements to each of the participating banks or financial institutions. The system also provides for net settlement of those adjustments through the participant's reserve account at the host Federal Reserve Bank or through a correspondent settling on the participant's behalf at the Federal Reserve Bank.

The central processor also allows for centralized administration of all cash letter adjustments. In this manner, reports can be generated for participating institutions that set forth the details of a history of adjustments. Alert values can be included so that institutions are notified upon receipt of an adjustment that is greater than a predetermined minimum. The centralized system can also provide daily summary reports and permit searching of data entries and past adjustments. The system also provides for administrative management by the system operator and necessary administrative functions for the system users. System users may select the financial institutions from whom they will receive adjustments.

### BRIEF DESCRIPTION OF THE DRAWINGS

FIG. 1 is a schematic representation of the proposed system with connection between a plurality of banks and the central exchange by the internet.

FIG. 2 is block diagram representation of the client-server model applied to the present system with the exchange located on the server side and the individual banks located on the client side.

FIG. 3 is a block diagram representation of a sample adjustment transaction in which one bank sends an adjustment to the central exchange and settlement information is transmitted to that bank, another bank and to the Federal Reserve Bank.

FIG. 4 is an illustration of the opening screen of the system of the present invention with a tool bar.

FIG. 5 is an illustration of the screen of the system of the present invention for preparation of a Listed Not Enclosed adjustment.

FIG. 6 is an illustration of the web form header of the present invention with data entry fields.

FIG. 7 is an illustration of the transaction fields for the Listed Not Enclosed adjustment transaction of the present invention.

FIG. 8 is an illustration of the transaction fields for the Encoding Error adjustment transaction of the present invention.

FIG. 9 is an illustration of the transaction fields and screen for the Documentation Adjustment/Response transaction of the present invention.

FIG. 10 is an illustration of the transaction section of the Document Adjustment/Response form of FIG. 9.

FIG. 11 is an illustration of the transaction fields for the Request for Information adjustment transaction of the present invention.

FIG. 12 is an illustration of a Daily Activity Report generated by the present invention.

### DETAILED DESCRIPTION OF THE PREFERRED EMBODIMENTS

As shown in FIG. 1, the system of the present invention includes one or more banks 10, 12, connected to a central exchange 14, through the internet 16 or other type of wire or wireless connection. Access to the electronic system of the present invention is secured by standard security protocol. Examples of such protocols include the use of personal identification numbers (PIN) and security tokens with access keys. In its preferred embodiment, the system contemplates use of a standard Windows-based application with an internet browser. Standard Window-based forms are contemplated, such as those using text boxes and scroll bar functions.

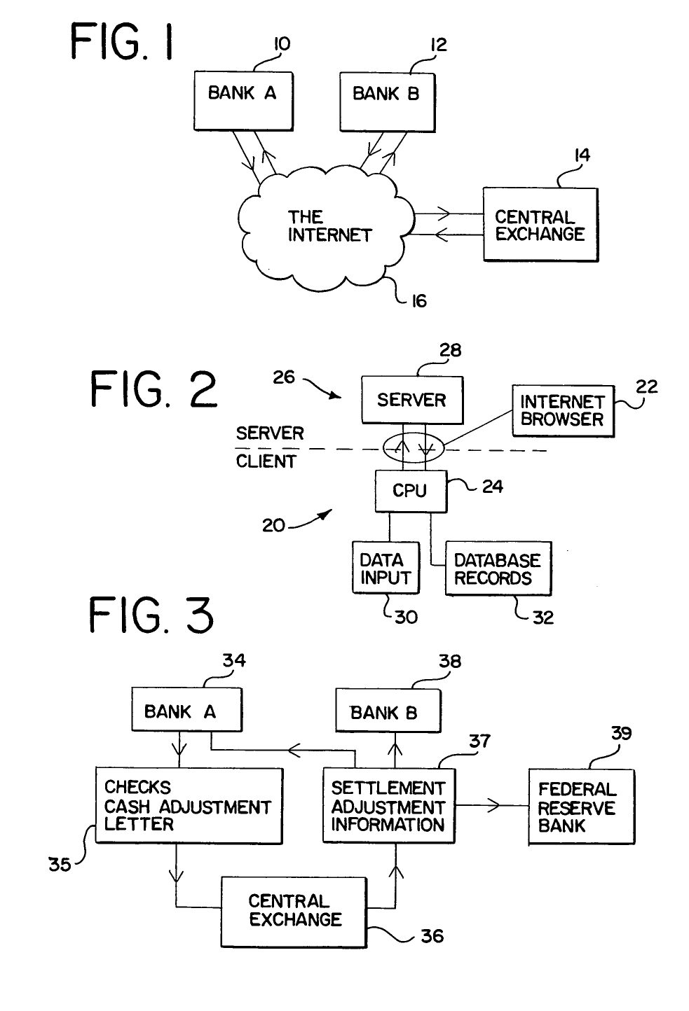

The system for use with the present invention may be a client/server environment, as well as other various environments, such as a conventional personal computer or other hardware and software systems. As shown in FIG. 2, the client system 20 is expected to include a conventional browser as well as a central processing unit (CPU) 24 and a memory.

The server system 26 includes a server engine 28 or search engine, and various databases of information relating to the exchange system. The server system also includes an information database, which is a collection of criteria or rules for implementation of the exchange system. The information database may be in the form of a look-up table, or similar structure, that provides output information based on the input of information obtained during the search of the other databases as acted upon by the rules of the logic structure of the system.

The system of the present invention can be operated by programs resident on the server side or operated by application programs that are executed by a CPU. Operator input 30 is possible through a keyboard or other known input devices such as batch transfer client. Database records 32, or other necessary information, can also be received from an external device or through an Internet connection or intranet connection, as known in the art. Each of the various databases may be stored or located in physically remote locations from one another or on a single client or single server system. Output is viewed through a standard graphical user interface or terminal or other known output devices.

Any type of search engine known in the art may be used to review the relevant records, such as structured query logic (SQL) or similar systems. The specific software code for implementation of the system of the present invention may be devised and written by one skilled in the art based on the logic structure and data inputs described herein. The present invention relates more generally to the exchange system for evaluation and review of the underlying data structure and database than to the specific software code implementation of the system.

An example of the type of system used with the present invention would be a web server, with a Windows based operating system, utilizing SQL 7.0 as a database tool, utilizing Internet Explorer 5.0 software for its Internet interface. Other systems and configurations are possible.

The system of the present invention has been commercially implemented in the form of the EDIBANX® system. The EDIBANX® system is organized and run by the Chicago Clearing House Association. An example of the type of exchange contemplated by the EDIBANX® system is shown in FIG. 3. A first bank 34, Bank A, sends a cash letter adjustment 35 to the central exchange 36. As described in more detail herein, the exchange 36 processes the cash letter adjustment and makes a settlement determination. Settlement information is communicated back to the first bank 34, to another bank 38, Bank B, which is involved in the adjustment and, in some cases, to a Federal Reserve Bank 39.

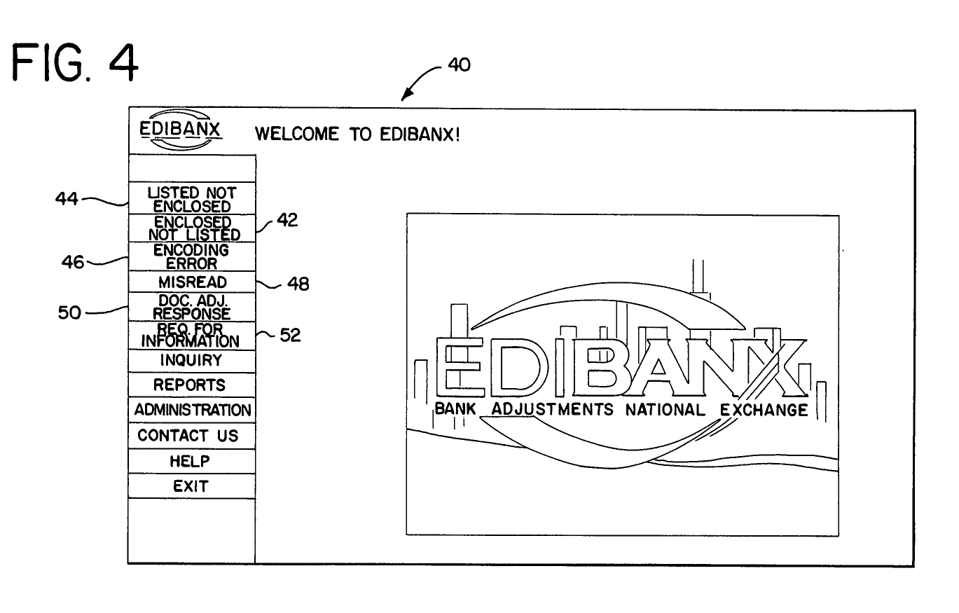

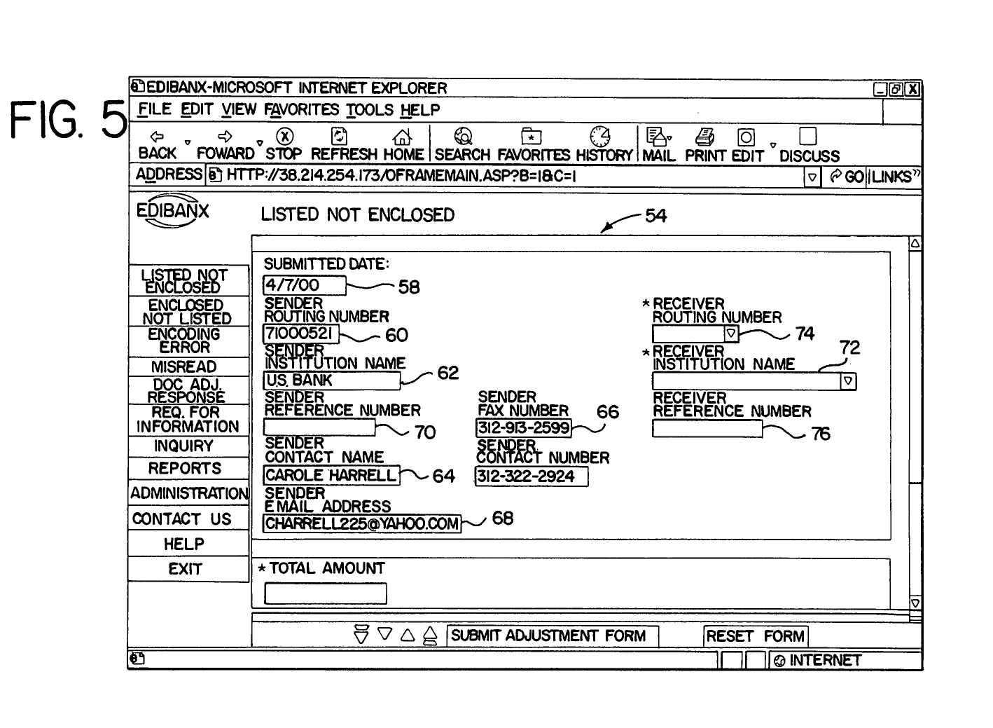

In general, the system permits the following categories of adjustments, which are shown in the opening screen 40 illustrated in FIG. 4: enclosed items that are not listed 42; listed items that are not enclosed or missing items 44; encoding errors 46; misread errors 48; documentation errors 50; or requests for information 52. Each of these adjustments will be discussed in more detail in the context of the operation of the system.

Proposed cash letter adjustments are entered onto a web-based electronic form. Each form is controlled or operated upon by business rules and has specific information requirements for each adjustment type or category. The business rules and information requirements are used to validate entries and establish and enforce a standard by which adjustments are processed. The business rules are built into the system and operate in the background.

Web forms for data entry, such as form 54 illustrated in FIG. 5, contain three sections: the header; the specific transaction section; and, the sublist. Every adjustment or request will have a header and transaction section. Sublists appear when necessary. The data entry operator moves from field to field in the form by use of tabs, as in a standard Windows-based system. The system will provide verification of the data entered by the operator. Some data are verified when the operator tabs out of, or exits, a field. Some data are verified when the adjustment is submitted to the central processor. An error message is displayed if invalid data have been entered into a field.

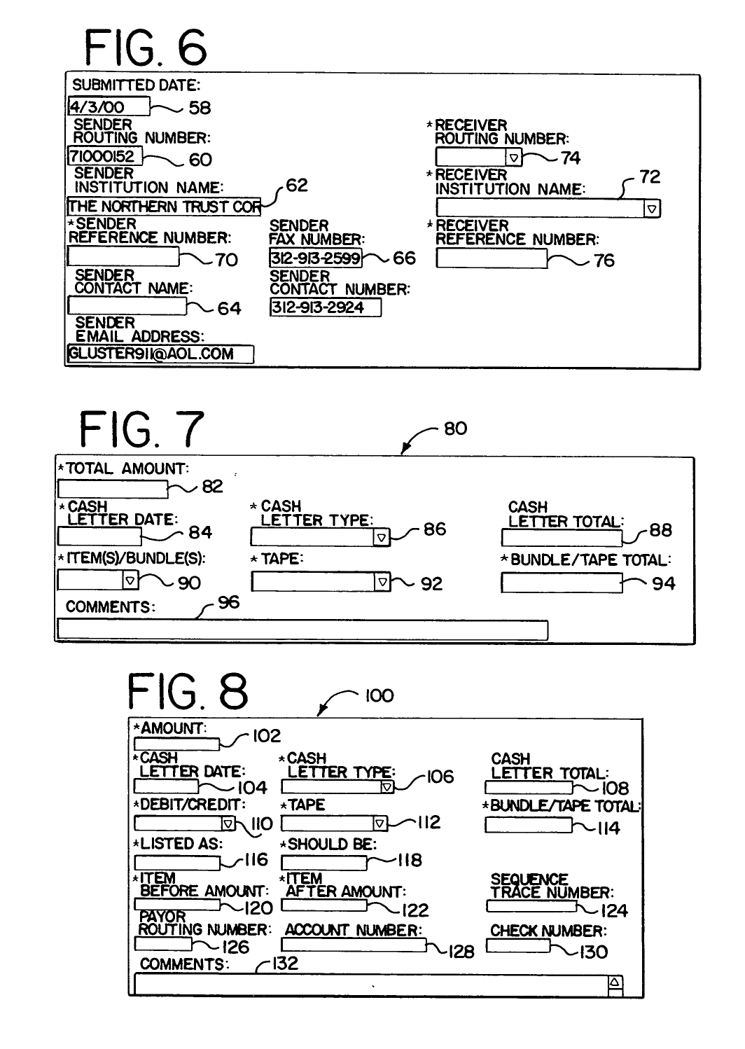

The form header, shown in FIGS. 5 and 6, includes the following: the date submitted 58 (the current date); sender routing number 60 (the ABA number of the sending institution); sender institution name 62; sender contact name 64 (which may be preauthorized by the central processor); sender fax and email addresses 66, 68; sender reference number 70 (which is an internal tracking number for the sender); receiver institution name 72 and receiver routing number 74 (which is the ABA number of the institutions that have agreed to receive adjustments from the sender—the system automatically populates this field upon entry of the receiver institution name); and, receiver reference number 76 (if known by the sender), the method of settlement; and, the depository account of the sender at the receiver. The transaction field will specify the adjustment type within certain categories of adjustments. Examples of the types of business rules that would apply to all adjustment categories and types would be: banks that present and receive forward items may not present adjustments less than $50; banks that only receive forward cash letters may not present adjustments less than $10. All date and amount fields are subject to validations for accuracy and coherence.

The data entry form also includes a transaction section. One example of a transaction adjustment would be the “Listed Not Enclosed/Missing Items” adjustment. This transaction form is used when an item or bundle was listed on the cash letter, but it was not received by the receiving bank. Other commonly used names for this type of adjustment include “Missing Items,” “Checks Missing,” and “Bundle Missing.” This is a debit to the receiving bank and a credit to the sending bank. To reduce clerical errors, the system does not offer the debit/credit option to the user. The preferred embodiment of the system permits listing up to five items in the transaction section provided they were included in the same bundle.

The Listed Not Enclosed Adjustment transaction section 80, shown in FIG. 7 includes the following fields for data entry: total amount of the adjustment 82; date of creation of the cash letter 84; type of cash letter (forward or return) 86; total dollar value listed on the cash letter 88; whether the adjustment involves a missing item or missing bundle 90; what type of tape listing was provided by the presenting bank, i.e., high speed or low speed tape 92; the total dollar value of the subject bundle or tape 94; and, a free format field 96 for miscellaneous comments pertaining to the adjustment.

The Listed Not Enclosed web form also includes a sublist. The sublist is used for listing of specific items that were listed in the missing items field. The sublist includes itemization of the dollar amount of the specific item or bundle; the dollar amount of the item before the subject item; the dollar amount after the subject item; and the sequence/trace number that was applied to the item in the cash letter preparation process. Data validation requires that the combined total of all “item before” and “item after” amounts entered cannot exceed the amount entered in the “bundle/tape” total field of the transaction section.

Another example of an adjustment transaction is the “Enclosed Not Listed” adjustment. The Enclosed Not Listed form pertains to an adjustment for receipt of an item drawn on the receiving institution that was not listed on the bundle listing nor included in the bundle total or cash letter total. This is a credit to the receiving bank and a debit to the sending bank. The system permits inclusion of up to five items in each transaction provided that they were included in the same bundle. In its preferred embodiment, to reduce clerical errors, the debit/credit option is not available to the user.

The Enclosed Not Listed transaction includes the following fields for data entry: total amount of the adjustment; date of creation of the cash letter; type of cash letter (forward or return); total dollar value listed on the cash letter; whether the adjustment involves a missing item or missing bundle; what type of tape listing was provided by the presenting bank, i.e., high speed or low speed tape; the total dollar value of the subject bundle or tape; and, a free format field for miscellaneous comments pertaining to the adjustment.

The Enclosed Not Listed web form also includes a sublist. The sublist is used for listing of specific items that were listed in the items/bundle field. The sublist includes itemization of the dollar amount of the specific item or bundle; an account number identifying the payer's account at the institution by or through which the item is payable; check serial number; and the sequence/trace number that was applied to the item in the cash letter preparation process. Data validation requires that the combined total amount of all items in the sublist must be equal to the total amount entered in the “Amount” field of the Enclosed Not Listed transaction section.

Another example of an adjustment transaction is the Encoding Error adjustment, which is shown in FIG. 8. The Encoding Error relates to a transaction in which an item was encoded for an amount different than the legal amount, was listed for the encoded amount and was included in the bundle and cash letter totals. This is either a credit or debit adjustment.

The Encoding Error transaction form 100 includes the following fields for data entry: total amount of the adjustment 102; date of creation of the cash letter 104; type of cash letter (forward or return) 106; total dollar value listed on the cash letter 108; whether the adjustment involves a debit adjustment 110 (which debits the receiver's account and credits the sender's account) or involves a credit adjustment (which credits the receiver's account and debits the sender's account); what type of tape listing was provided by the presenting bank 112, i.e., high speed or low speed tape; the total dollar value of the subject bundle or tape 114; the dollar amount of the item as listed 116; the correct dollar amount of the item 118; the dollar amount of the item before the subject item 120; the dollar amount of the item after the subject item 122; a sequence trace number 124 that is applied to the item during the cash letter preparation process; a payor routing number 126, which identifies the institution by or through which the item is payable; an account number 128 for the payor's account at the institution by or through which the item is payable; the serial number of the check 130; and, a free format field 132 for miscellaneous comments pertaining to the adjustment.

Another example of an adjustment transaction is a Misread adjustment, also called “Listing Error.” The Misread relates to when an item was read and processed as an amount different from the encoded amount. This may be either a credit or debit adjustment.

The Misread transaction form includes the following fields for data entry: total amount of the adjustment; date of creation of the cash letter; type of cash letter (forward or return); total dollar value listed on the cash letter; whether the adjustment involves a debit adjustment (which debits the receiver's account and credits the sender's account) or involves a credit adjustment (which credits the receiver's account and debits the sender's account); what type of tape listing was provided by the presenting bank, i.e., high speed or low speed tape; the total dollar value of the subject bundle or tape; the dollar amount of the item as listed; the correct dollar amount of the item; the dollar amount of the item before the subject item; the dollar amount of the item after the subject item; a sequence trace number that is applied to the item during the cash letter preparation process; a payor routing number, which identifies the institution by or through which the item is payable; an account number for the payor's account at the institution by or through which the item is payable; the serial number of the check; and, a free format field for miscellaneous comments pertaining to the adjustment.

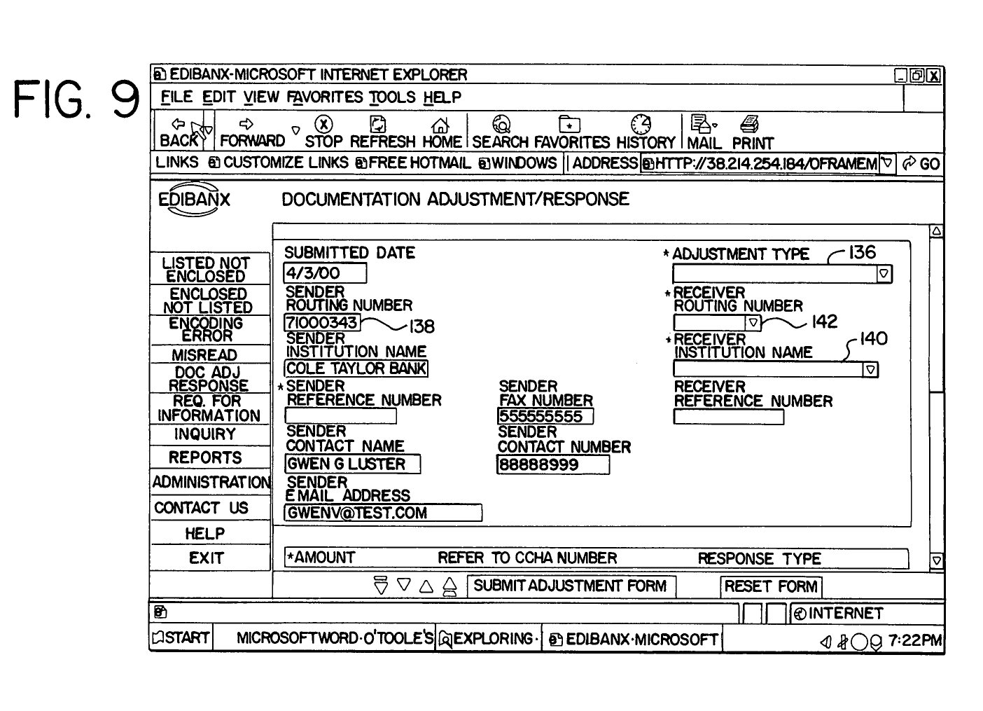

Another example of an adjustment transaction or category contemplated by the present system is called a “Documentation Adjustment/Response,” which is shown in FIG. 9. This transaction is used when the initiator of the transaction must send an item of value, such as a check, or evidence of an alteration to complete the adjustment. The described document is integral to the transaction as substantiating evidence; it is not only supporting documentation. The Adjustment Type field 136 is used to identify the type of Documentation Adjustment being submitted.

Examples of Documentation Adjustment transactions are as follows: empty carrier, in which an item was charged and the bank received the carrier but not the item; error in addition, which is typically caused by manual changes to machine produced listings; misdirected return, in which an item was charged back to one participant but intended for another; non-negotiable item, which is an item that does not meet negotiability requirements, such as a pre-encoded deposit ticket; “not our item,” which is an erroneously charged item, such as missorted checks; “photo in lieu of original,” in which a photograph is being submitted due to a lost or destroyed item; “photo: original paid,” in which an item is being refused either because a photocopy of the original check or the original check itself has already been paid; and reversal, in which it is discovered that an adjustment was entered or received in error and may be reversed.

The Documentation Adjustment header 134 includes the following fields for data entry: sender reference number 138, which is an internal number assigned by the sender; adjustment type 136, which is an identification of the type of adjustment being submitted (e.g., Empty Carrier, Error in Addition, Misdirected Return, Non-Negotiable Item, Not Our Item, Photo: In Lieu of Original, Photo: Original Paid, Other); and, receiver institution name 140 and receiver routing number 142, which is a list box containing the ABA numbers of all banks that have agreed to receive adjustments from the presenting bank.

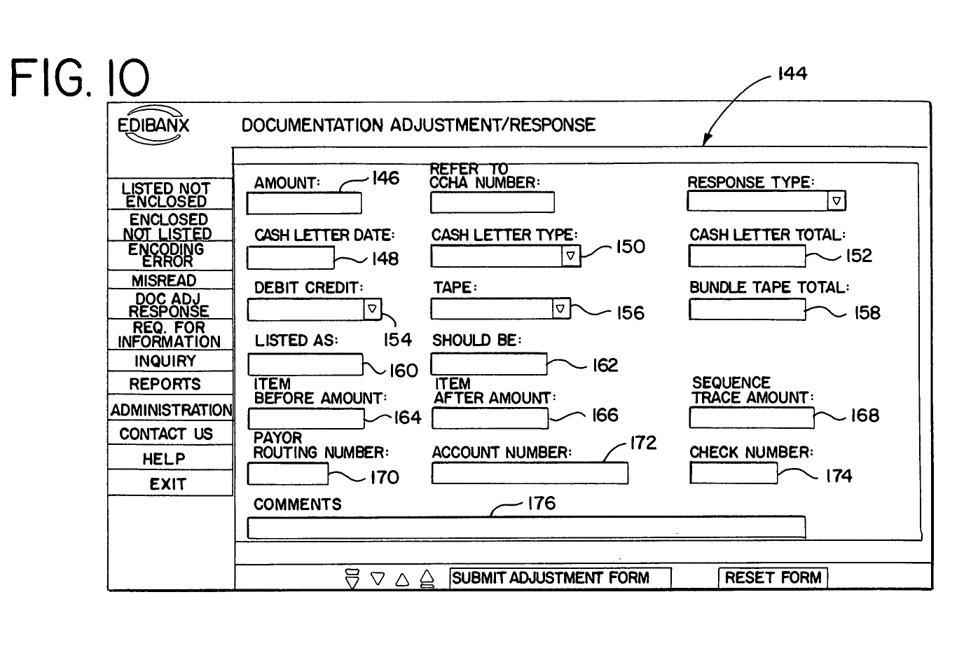

The Documentation Adjustment form also includes a transaction section 144, which is shown in FIG. 10. The transaction section includes the following fields: total amount of the adjustment 146; date of creation of the cash letter 148; type of cash letter (forward or return) 150; total dollar value listed on the cash letter 152; whether the adjustment involves a debit adjustment 154 (which debits the receiver's account and credits the sender's account) or involves a credit adjustment (which credits the receiver's account and debits the sender's account); the debit/credit field will pre-fill with the selection of certain adjustment types; what type of tape listing 156 was provided by the presenting bank, i.e., high speed or low speed tape; the total dollar value of the subject bundle or tape 158; the dollar amount of the item as listed 160; the correct dollar amount of the item 162; the dollar amount of the item before the subject item 164; the dollar amount of the item after the subject item 166; a sequence trace number 168 that is applied to the item during the cash letter preparation process; a payor routing number 170, which identifies the institution by or through which the item is payable; an account number 172 for the payor's account at the institution by or through which the item is payable; the serial number of the check 174; and, a free format field 176 for miscellaneous comments pertaining to the adjustment.

Documentation Adjustment transactions require documentation. Documentation may scanned and sent electronically or it may be sent in paper form.

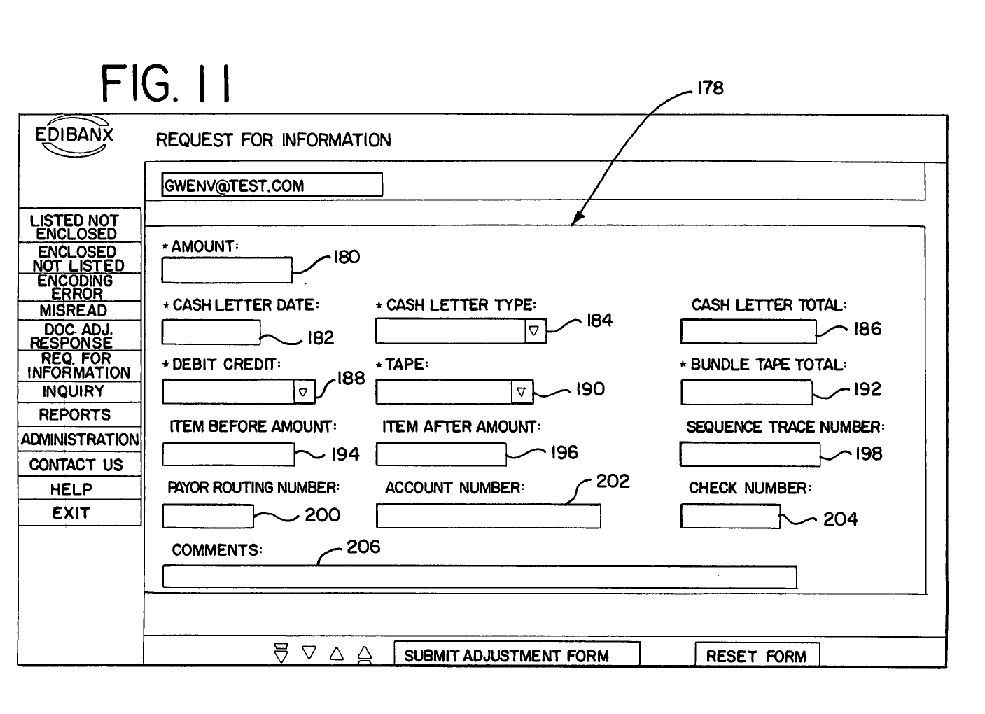

Another example of an adjustment transaction or category contemplated by the present system is a Request for Information, which is shown in FIG. 11. These transactions are used for the following adjustment types: a disposition request, which identifies to whom the subject item was presented; a photocopy request, which is sent to prove an error or to serve as a replacement for a lost or destroyed forward or return item; and, a source of receipt, which identifies from whom an item was received.

The Request for Information form 178 includes the following fields: total amount 180 of the adjustment; date of creation 182 of the cash letter; type of cash letter 184 (forward or return); total dollar value 186 listed on the cash letter; whether the adjustment involves a debit adjustment 188 (which debits the receiver's account and credits the sender's account) or involves a credit adjustment (which credits the receiver's account and debits the sender's account); what type of tape 190 listing was provided by the presenting bank, i.e., high speed or low speed tape; the total dollar value 192 of the subject bundle or tape; the dollar amount of the item before the subject item 194; the dollar amount of the item after the subject item 196; a sequence trace number 198 that is applied to the item during the cash letter preparation process; a payor routing number 200, which identifies the institution by or through which the item is payable; an account number 202 for the payor's account at the institution by or through which the item is payable; the serial number 204 of the check; and, a free format field 206 for miscellaneous comments pertaining to the adjustment.

According to the business rules, a bank or financial institution has 21 or 45 calendar days to respond to a request for information. The amount of time is determined by the difference between the cash letter date and the date the request is submitted. The receiving bank has 21 calendar days to respond if the difference is less than 180 calendar days. If the difference is more than 180 calendar days, the receiving bank has 45 calendar days to respond. If the receiving bank responds, the transaction becomes non-financial. If the receiving bank does not respond, the transaction becomes financial and will settle.

The Response to Request for Information Adjustment category includes several types of transactions. These include: a response to a disposition request; a response to a photocopy request; a response to source of receipt request; and, a response to a without entry.

Users are also given the ability to reverse an adjustment entered in error. To access the reversal, the sender views the detail report for an item and clicks the “reverse” button. This button feature is available only when the sending bank is viewing the transaction detail. The system will enter a transaction of the category and type and amount. However, the debit and credits will proceed in opposite directions from the “reversed” transaction, which, in effect, washes the transaction. The sender can reverse an adjustment using this method as long as it has not settled. To reverse an adjustment that has settled, the user must select the “Other” adjustment category.

The exchange system operates under business rules that require responses from a member institution that receives a Request for Information. Documentation may be scanned and sent electronically or it may be sent in paper form. The system also allows for initiation of claims for reimbursement (“late return claims”), subject to clearinghouse rules or other agreements, of the amount of a check that is made in the event an item is not returned timely to the bank of first deposit, which results in a financial loss. Documentation is also provided by the system for recordation of honoring of a claim by an institution as well as dishonoring (disclaimer) of a claim by an institution.

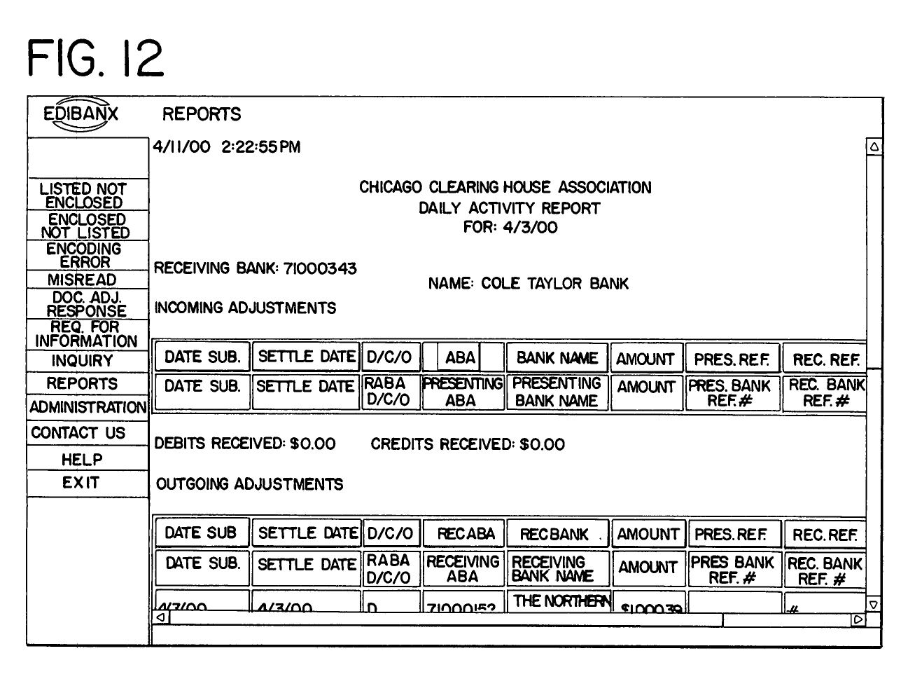

The present system of electronic adjustments also stores the results of each institution's electronic adjustment activity. Authorized users from each institution can access a summary of that institution's electronic adjustment activity. A Daily Activity Report, which is shown in FIG. 12, summarizes all incoming, outgoing, and pending adjustments. The report contains a line item for each adjustment. Each line item has fields of related data regarding that transaction, including the transaction's financial effect on the receiving bank, such as a debit, credit or non-financial. The user can view the details of any line item as well as an institution's Settlement Participant Balance Report.

The database of adjustment activity can also be searched for individual items including, but not limited to, reference to total dollar amount of the transaction; total dollar amount of the bundle in question; routing/transit number; start or end dates; or various case numbers.

Administration of the exchange is monitored by the central processing function. A registration system provides a listing of users for each institution. Also, each institution can set an “alert value,” which is a notification function for the institution upon receipt of an adjustment equal to or greater than a specified amount.

What is claimed is:

1. An electronic exchange system for processing cash letter adjustments between a plurality of authorized financial institutions, including a sender institution, a receiver institution and a central exchange center, said system comprising:
means for entry of adjustment data into said system, said data including sender institution information, receiver institution information, adjustment amount information, and data validation information,
processor means for processing said adjustment data, said processing means including means for validation of said data, said processing means including sorting means for sorting said data by sender institution and receiver institution, and,
notification means for notifying said sender institution and said receiver institution of adjustment data after successful validation by said processing means.

2. The system of claim 1 wherein said processor means includes calculation means for determining net adjustments between said sender institution and said receiver institution.

3. The system of claim 2 wherein said notification means includes notifying said central exchange of said net adjustment, said central exchange including an account system for adjustment of accounts of said sender institution and said receiver institution by said net adjustment amount.

4. The system of claim 1 wherein said adjustment data includes one or more adjustment transactions selected from the group: enclosed items not listed, listed items not enclosed, encoding errors, misread errors, documentation errors, and requests for information.

5. The system of claim 4 wherein said data includes information selected from the group: the date of submission, sender routing number, sender institution name, and receiver institution name.

6. The system of claim 1 wherein said validation information includes a series of business rules and information requirements utilized by said processor means.

7. The system of claim 6 wherein said business rules include amount limits on adjustment for different member institutions.

8. The system of claim 4 wherein said listed items not enclosed adjustment includes at least two or more of the following data: total amount of adjustment; cash letter creation date; cash letter type; cash letter total dollar value listed; missing item adjustment; missing bundle adjustment; tape listing type; tape total dollar.

9. The system of claim 8 wherein said listed items not enclosed includes itemization of the dollar amount of the specific item or bundle; the dollar amount of the item before the subject item; the dollar amount after the subject item; and the sequence/trace number that was applied to the item in the cash letter preparation process.

10. The system of claim 9 wherein said data validation requires that the combined total of all “item before” and “item after” amounts entered cannot exceed the amount entered in the “bundle/tape” total field of the transaction section.

11. The system of claim 4 wherein said adjustment data includes one or more adjustment transactions selected from the group: empty carrier; error in addition; misdirected return; non-negotiable item; “not our item”; “photo in lieu of original”; “photo: original paid”; free item; and reversal.
